(19) United States
(12) Patent Application Publication
(10) Pub. No.: US 2022/0400517 A1
(43) Pub. Date: Dec. 15, 2022

(54) SCHEDULING REQUEST FOR TRANSMISSION OF DATA

(71) Applicant: Telefonaktiebolaget LM Ericsson (publ), Stockholm (SE)

(72) Inventors: Torsten DUDDA, Wassenberg (DE); Abdulrahman ALABBASI, Kista (SE); Henrik ENBUSKE, Stockholm (SE); Reem KARAKI, Aachen (DE); Zhenhua ZOU, Solna (SE)

(21) Appl. No.: 17/776,124

(22) PCT Filed: Nov. 11, 2019
(86) PCT No.: PCT/EP2019/080892

§ 371 Date: May 11, 2022

(51) Int. Cl. H04W 74/08; H04W 16/14; H04W 72/12

(52) U.S. Cl. CPC H04W 74/0808; H04W 16/14; H04W 72/12

(57) ABSTRACT

Methods and apparatus are provided. In an example aspect, a method performed by a wireless device is provided. The method includes initiating a procedure to determine whether a channel in unlicensed spectrum for transmission of data to a base station using unlicensed spectrum is occupied, and before completion of the procedure, transmitting a scheduling request to the base station, the scheduling request for transmission of the data to the base station using licensed spectrum.

### TECHNICAL FIELD

Examples of the present disclosure relate to transmission and reception of a scheduling request for transmission of data. In some examples, a wireless device will also attempt to transmit the data using unlicensed spectrum, for example by initiating a procedure to determine whether a channel in unlicensed spectrum is occupied.

### BACKGROUND

The present application is presented within the context of 3GPP New Radio (NR) 5G wireless communication technology (e.g. 3GPP TS 38.300 V15.6.0 (2019-06), which is incorporated herein by reference). It is understood that the problems and solutions described herein are equally applicable to wireless access networks and user-equipments (UEs) implementing other access technologies and standards.

In addition to operation in licensed bands, NR may be developed (e.g. in Rel-16, as specified in 3GPP work item RP-190706, Revised WID on NR-based Access to Unlicensed Spectrum) to allow operation in unlicensed bands, i.e. NR-unlicensed (NR-U). Allowing unlicensed networks, i.e. networks that operate in shared spectrum (or unlicensed spectrum), to effectively use the available unlicensed spectrum is an attractive approach to increase network capacity. Although unlicensed spectrum may not match the qualities of licensed spectrum, solutions that allow an efficient use of unlicensed spectrum as a complement to licensed deployments may be of interest. Some features in NR may need to be adapted to comply with the special characteristics of unlicensed spectrum as well as to comply with different regulations. When operating in unlicensed spectrum, many regions in the world require a device to sense the medium (e.g. a channel in unlicensed spectrum that a device intends to use for transmission) as free or unoccupied before transmitting. This operation is often referred to as listen before talk, LBT. There are many different approaches for LBT depending on which radio technology the device uses and which type of data it intends to transmit. Common for all approaches is that the sensing is done for a particular channel (corresponding to a defined carrier frequency) and over a predefined bandwidth. For example, in the 5 GHz band, the sensing is done over 20 MHz bandwidth.

In another 3GPP work item RP-190728 (NR Industrial Internet of Things (IoT)), features developed and specified for NR release 16 (Rel-16) to support Industrial Internet of Things use cases include features for efficient handling of time sensitive networking/communication (TSN/TSC) traffic. This traffic consists typically of frequent, periodical, small Ethernet frames with demanding latency and reliability requirements (e.g. ultra-reliable and low latency communication, URLLC). URLLC is one of the main use cases of 5G NR. URLLC has strict requirements on transmission reliability and latency, e.g. 99.9999% reliability within 1 ms one-way latency. In NR Rel-15, several new features and enhancements were introduced to support these requirements. In Rel-16, standardization works are focused on further enhancing URLLC system performance as well as ensuring reliable and efficient coexistence of URLLC and other NR use cases. One example scenario is when both enhanced mobile broadband (eMBB) and URLLC services are run within the same UE.

Time Sensitive Networking (TSN) is a set of features that allow deterministic networking in Ethernet based wired communication networks. Within a TSN network, communication endpoints are called Talker and Listener. All the switches (bridges) in between Talker and Listener need to support certain TSN features, e.g. IEEE 802.1AS time synchronization. All nodes that are synchronized in the network belong to a so-called TSN domain. TSN communication is only possible within such a TSN domain. To allow for deterministic communication, TSN communication occurs in streams that are set up across the TSN domain before data communication takes place. 3GPP Rel-16 develops methods to allow integration of the 5G NR system as a virtual bridge within a TSN network, such as mapping/translation of TSN stream requirements to 5G system internal requirements such as packet delay budget and error rates, as well as mapping of corresponding TSN streams to PDU sessions and QoS flows. Features may be defined in 3GPP to support providing deterministic latency over the NR radio interface.

In licensed spectrum operation, uplink traffic from a wireless device such as a UE can be scheduled with dynamic uplink grants or configured uplink grants. In case of dynamic grants, the gNB provides an uplink grant (a scheduling grant) to the UE for each uplink transmission. Configured grants are pre-allocated, i.e. provided once to the UE. Thereafter, the configured uplink grant is valid for usage for uplink transmissions according to a configured periodicity. The UE does not need to transmit padding on those uplink resources corresponding to a configured grant if no uplink data is available for transmission, i.e. may skip an uplink transmission on such resources. The Logical channel Prioritization (LCP) procedure at the UE MAC determines the order of priority and amount of data from each logical channel to be multiplexed and transmitted in an uplink transmission, i.e. when an uplink grant is received. Logical channel mapping restrictions can be defined, e.g. restricting certain logical channels to be transmitted on an uplink grant referring to certain serving cells or being of certain transmission duration. This way, URLLC traffic requiring a certain low latency can be restricted to be transmitted on too long uplink slots or unreliable serving cells.

Both dynamic uplink grants or configured uplink grants are also supported on unlicensed carriers in unlicensed spectrum. Nonetheless, enhancements may be adopted given the special characteristics of the unlicensed carrier. For instance, multi-slot scheduling is specified in 3GPP Rel-16 that allows scheduling multiple slots using single grant. The motivation here is to reduce scheduling grant transmission overhead on an unlicensed carrier. Similarly, the HARQ procedure for configured uplink grant on an unlicensed carrier is different from the licensed carrier. If the UE does not receive feedback within a certain time, the UE has to assume NACK instead of ACK, which is more suitable given the non-guaranteed nature of the unlicensed carrier.

### SUMMARY

One aspect of the present disclosure provides a method performed by a wireless device. The method comprises initiating a procedure to determine whether a channel in unlicensed spectrum for transmission of data to a base station using unlicensed spectrum is occupied, and before completion of the procedure, transmitting a scheduling request to the base station, the scheduling request for transmission of the data to the base station using licensed spectrum.

Another aspect of the present disclosure provides a method performed by a base station. The method comprises receiving a scheduling request for transmission of data from a wireless device, the scheduling request for transmission of the data from the wireless device to the base station using licensed spectrum, and determining that the wireless device will attempt to transmit the data to the base station using unlicensed spectrum.

A further aspect of the present disclosure provides apparatus comprising a processor and a memory. The memory contains instructions executable by the processor such that the apparatus is operable to initiate a procedure to determine whether a channel in unlicensed spectrum for transmission of data to a base station using unlicensed spectrum is occupied, and before completion of the procedure, transmit a scheduling request to the base station, the scheduling request for transmission of the data to the base station using licensed spectrum.

A still further aspect of the present disclosure provides apparatus comprising a processor and a memory. The memory contains instructions executable by the processor such that the apparatus is operable to receive a scheduling request for transmission of data from a wireless device, the scheduling request for transmission of the data from the wireless device to the base station using licensed spectrum, and determine that the wireless device will attempt to transmit the data to the base station using unlicensed spectrum.

Another aspect of the present disclosure provides apparatus configured to initiate a procedure to determine whether a channel in unlicensed spectrum for transmission of data to a base station using unlicensed spectrum is occupied, and before completion of the procedure, transmit a scheduling request to the base station, the scheduling request for transmission of the data to the base station using licensed spectrum.

An additional aspect of the present disclosure provides apparatus configured to receive a scheduling request for transmission of data from a wireless device, the scheduling request for transmission of the data from the wireless device to the base station using licensed spectrum, and determine that the wireless device will attempt to transmit the data to the base station using unlicensed spectrum.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method performed by a wireless device;

FIG. 2 is a flow chart of an example of a method performed by a base station;

FIG. 3 is a schematic of an example of apparatus such as for example a wireless device or User Equipment (UE); and

FIG. 4 is a schematic of an example of apparatus such as for example a base station or gNB.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry.

Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Although examples of this disclosure are in the context of 3GPP NR technology, as indicated above it is understood that the problems and solutions described herein are equally applicable to wireless access networks and user-equipments (UEs) implementing other access technologies and standards, such as for example LTE and Wi-Fi. NR is used as an example technology, and using NR in the description therefore is particularly useful for understanding the problem and solutions. However, this disclosure should not be understood as restricting particular examples to any particular technology. In particular, examples of this disclosure are also applicable to 3GPP LTE, 3GPP LTE and NR integration (non-standalone NR or EN-DC) and/or other wireless communication technologies.

Some communications such as for example URLLC may in some examples have large bandwidth requirements given the need for extremely robust encoding techniques. Licensed spectrum for NR operation may however be scarce and expensive, but nonetheless can guarantee high reliability and QoS levels. Therefore NR operation in unlicensed spectrum, including for communications needing high reliability and/or low latency such as URLLC, is considered. However, it is unclear how requirements for communications such as for example URLLC and/or TSN, such as reaching a deterministic low latency performance and/or high reliability, can be achieved by operation in unlicensed shared spectrum that is primarily used for best effort services.

Examples of this disclosure may provide methods and apparatus to meet high reliability and/or low latency targets, even when unlicensed spectrum is used. In some examples, for a data transmission (e.g. associated with a logical channel configured for this functionality), data transmission is attempted on an unlicensed carrier by determining whether a channel that is to be used for the transmission is occupied, e.g. using Clear Channel Assessment (CCA) or Listen Before Talk (LBT). At the same time, a scheduling request (SR) (requesting resources for transmitting the same data) is triggered on a licensed carrier. When the radio network, such as for example a base station or gNB, detects the transmission on the unlicensed carrier and the SR for licensed carrier, it may not schedule resource on licensed carrier for the UE. For example, the network may ignore the scheduling request. Benefits of examples of this disclosure may include The benefits include meeting reliability and/or latency targets by using unlicensed spectrum complemented by licensed spectrum, and/or reducing dependency on the licensed spectrum to meet reliability targets.

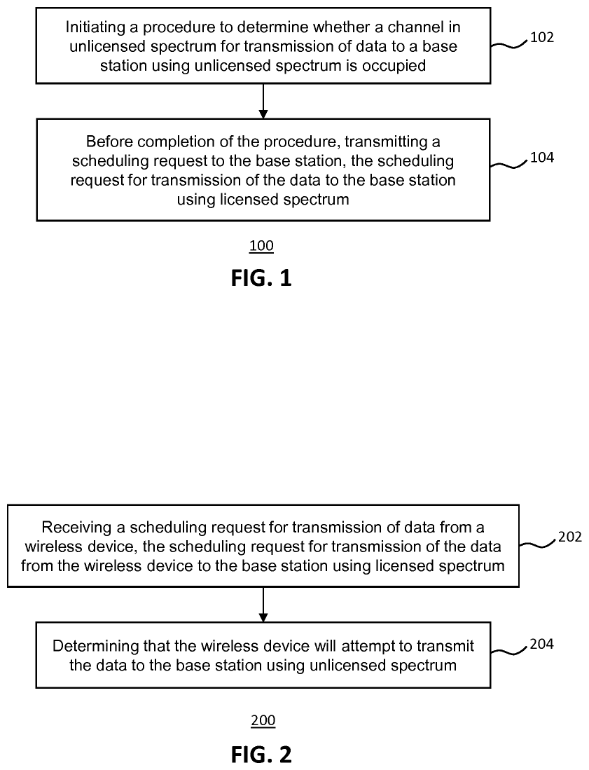

FIG. 1 is a flow chart of an example of a method 100 performed by a wireless device, such as for example a UE. The method 100 comprises, in step 102, initiating a procedure to determine whether a channel in unlicensed spectrum for transmission of data to a base station (e.g. gNB) using unlicensed spectrum is occupied. For example, the procedure comprises a Listen Before Talk (LBT) procedure or a Clear Channel Assessment (CCA) procedure. In step 102, the method 100 comprises, before completion of the procedure, transmitting a scheduling request to the base station, the scheduling request for transmission of the data to the base station using licensed spectrum. In some examples, the data may comprise one or more packets, and/or may comprise URLLC data or any other reliability- and/or latency-sensitive data.

Therefore, for example, the UE may begin an attempt to transmit on the unlicensed spectrum, and before the UE completes this procedure (e.g. before the UE has determined whether or not the channel is occupied, or if the channel is available and transmission can begin), a scheduling request for resources to transmit the same data on licensed spectrum is made. In some examples, initiation of transmission of the scheduling request may begin simultaneously with initiating the procedure, or alternatively before initiating the procedure. In the latter case, in some examples, the procedure may be initiated before receiving a scheduling grant from the base station in response to the scheduling request.

In some examples, after completion of the procedure, the method 100 comprises transmitting the data to the base station using the unlicensed spectrum. This may be for example because the procedure indicates that the channel is not occupied. The method 100 may then comprise receiving a scheduling grant for transmitting the data on licensed spectrum after transmitting the data to the base station using the unlicensed spectrum, e.g. in response to the scheduling request. However, the data has already been transmitted on the unlicensed spectrum, and in some examples the wireless device may have received positive feedback from the base station such as an acknowledgement that the transmission on the unlicensed spectrum has been successfully decoded. The method 100 may there for comprise ignoring the scheduling grant. In some examples, the wireless device may cancel any preparations for transmission of the data on licensed spectrum after transmitting the data to the base station using the unlicensed spectrum and/or if transmitting the data to the base station using the unlicensed spectrum is successful (e.g. as indicated by an acknowledgement or similar).

In some examples, the data is transmitted to the base station using the unlicensed spectrum, and the wireless device may determine that the transmission was unsuccessful. For example, the wireless device may receive a negative acknowledgement (NACK) or may not receive a positive or negative acknowledgement in a certain period of time, or alternatively may receive a retransmission request. Therefore, the method 100 may comprise attempting to retransmit the data to the base station using unlicensed spectrum. This may involve the wireless device performing another procedure to determine whether the channel in unlicensed spectrum for transmission of data to a base station using unlicensed spectrum is occupied, such as for example another LBT or CCA procedure. The method 100 may also comprise cancelling preparations for transmission of the data on licensed spectrum if retransmission of the data to the base station using unlicensed spectrum is successful (e.g. if the retransmission is successfully transmitted, and/or if an acknowledgement for the retransmission is received).

In some examples, if the data is transmitted to the base station using the unlicensed spectrum, an indication may be included with the data that the scheduling request for transmission of the data was transmitted to the base station. Thus, the base station may be able to identify that the unlicensed spectrum transmission relates to the scheduling request, that is, that the unlicensed spectrum transmission contains data which would have been transmitted on the licensed spectrum if a scheduling grant is given and if the unlicensed spectrum transmission did not take place. Hence, the base station can take appropriate action, e.g. cancel the scheduled transmission and/or ignore the scheduling grant.

The procedure in step 102 of the method 100 may in some examples indicate that the channel for transmission of the data to the base station using unlicensed spectrum is occupied. The method 100 may then comprise for example receiving a scheduling grant for transmission of the data to the base station using licensed spectrum, and transmitting the data to the base station using licensed spectrum.

The base station may identify that the scheduling request relates to data that the wireless device will also attempt to transmit on unlicensed spectrum. For example, the wireless device may transmit the scheduling request using a predetermined resource and/or logical channel, wherein transmitting the scheduling request using the predetermined resource and/or logical channel indicates that the wireless device has initiated the procedure to determine whether the channel in unlicensed spectrum for transmission of data to a base station using unlicensed spectrum is occupied. The base station may then be able to take appropriate action, e.g. provide a scheduling grant if the data is not received on unlicensed spectrum (or is not successfully decoded), or ignoring the scheduling request or cancelling any scheduling of the transmission of the data if the data is successfully received on the unlicensed spectrum.

In some examples, the wireless device may only be permitted to send a further scheduling request (for further data) if the scheduling earlier scheduling request was sent not within a predetermined time. Therefore, the method 100 comprises starting a timer on transmitting the scheduling request, and initiating a further procedure to determine whether the channel in unlicensed spectrum for transmission of the further data to the base station using unlicensed spectrum is occupied. Before completion of the further procedure, the wireless device may transmit a further scheduling request for transmission of the further data to the base station using licensed spectrum if the timer indicates that at least a predetermined time has passed since transmitting the scheduling request. In some examples, on expiry of the timer after the predetermined time (and in some examples before having any further data to transmit, and thus before sending the further scheduling request), if a scheduling grant for transmission of the original data using licensed spectrum has not been received, and the data has not been successfully transmitted to the base station using unlicensed spectrum, the wireless device may send a further scheduling request to the base station for transmission of the data to the base station using licensed spectrum.

FIG. 2 is a flow chart of an example of a method 200 in a base station, such as for example a gNB. The method 200 comprises, in step 202, receiving a scheduling request for transmission of data from a wireless device (e.g. a UE), the scheduling request for transmission of the data from the wireless device to the base station using licensed spectrum. The wireless device may be a wireless device performing the method 100 as disclosed above. The method 200 also comprises, in step 204, determining that the wireless device will attempt to transmit the data to the base station using unlicensed spectrum. Once this determination is made in step 204, the base station may take appropriate action. For example, the base station may ignore the scheduling request on receiving the data using unlicensed spectrum, and/or cancel any scheduling of transmission of the data by the wireless device on the licensed spectrum. The data may comprise data with low latency and/or high reliability requirements, such as for example URLLC data.

In some examples, determining in step 204 that the wireless device will attempt to transmit the data to the base station using unlicensed spectrum comprises receiving the data on unlicensed spectrum. The base station may for example be able to determine that the data is received in the unlicensed spectrum is the same as the data that relates to the scheduling request, e.g. that may be transmitted if a scheduling grant is returned. For example, an indication may be received with the data on unlicensed spectrum that indicates that the scheduling request corresponds to the data. In some examples, the data received on the unlicensed spectrum is incorrectly decoded. The base station may then receive a retransmission of the data from the wireless device using unlicensed spectrum.

In step 204 of the method 200 in some examples, determining that the wireless device will attempt to transmit the data to the base station using unlicensed spectrum comprises receiving the scheduling request using a predetermined resource and/or logical channel, wherein receiving the scheduling request using the predetermined resource and/or logical channel indicates that the wireless device has initiated a to determine whether a channel in unlicensed spectrum for transmission of data to a base station using unlicensed spectrum is occupied (e.g. a LBT or CCA procedure).

In some examples, the base station may start a timer on receiving the scheduling request. On expiry of the timer after a predetermined time, the base station may send a scheduling grant to the wireless device for transmission of the data from the wireless device to the base station using licensed spectrum (e.g. if the base station has not yet received the data on unlicensed spectrum). The base station may also stop the timer on receiving the data on unlicensed spectrum.

Particular examples will now be described. Some examples of this disclosure provide mechanisms to meet high reliability and/or low latency targets even when unlicensed spectrum is used. For example, for a data transmission of a logical channel configured for this functionality, data transmission is attempted on an unlicensed carrier e.g. using listen before talk (LBT) or clear channel assessment (CCA). At the same time, or at least before completion of the LBT or CCA procedure, a scheduling request (SR) is triggered on a licensed carrier. Completion of the procedure may comprise for example gaining access to the unlicensed channel in LBT, or CCA providing a result indicating whether the unlicensed channel is occupied or not. The SR may even in some examples be triggered before the procedure (e.g. LBT/CCA) is commenced. When the base station registers the transmission on the unlicensed carrier and SR for licensed carrier, and the gNB is able to successfully decode that transmission on the unlicensed channel, it may ignore the SR, i.e. does not schedule resource on licensed carrier for the UE, or frees any scheduled resources. This way, offloading of data transmission from licensed spectrum may be achieved. For example, whenever unlicensed transmissions are successful, licensed resources are not utilized and can be scheduled to other users.

In another scenario, the procedure is successful (e.g. the data is transmitted on the unlicensed spectrum), but transmission fails (e.g. an acknowledgement is not received at the wireless device, or a negative acknowledgement is received). The data is retransmitted only on the unlicensed carrier based on current mechanisms. For example, if the base station detects the transmission on the unlicensed carrier, it can ignore the SR, since the MAC PDU has been assembled and will be re-transmitted on the unlicensed carrier using, for example, autonomous retransmission. If the base station does not detect the transmission on the unlicensed carrier, it does not ignore the SR and may send an dynamic uplink grant on the licensed carrier. In this case, since the MAC PDU has been assembled, UE cannot transmit the MAC PDU on the licensed carrier.

In a first example, a data packet of a certain logical channel at the wireless device (referred to in this and other examples as a UE) is available for transmission. The UE triggers a scheduling request (SR) on licensed spectrum while at the same time attempting transmission of the packet on unlicensed, even if there are resources available on unlicensed, e.g. on configured grant (CG). The CCA/LBT procedure (or transmission of the packet) might fail, however in this example, the procedure is successful and the packet is transmitted on the unlicensed spectrum, and is successfully received at the base station. The base station notices this transmission, and also receives the SR (e.g. at the same time), and thus cancels the scheduling (e.g. ignores scheduling request received) and does not schedule the UE on licensed spectrum for the data to be transmitted. In another example, a packet arrives at the UE for transmission, and again both SR on licensed spectrum and the procedure (e.g. CCA/LBT) on unlicensed spectrum are triggered. In this case, the procedure fails so that no transmission on unlicensed takes place (or transmission on unlicensed spectrum fails, and cannot be decoded successfully at the base station). Therefore, the base station will undergo the legacy SR-based scheduling mechanism, i.e. schedule an uplink grant for the UE on licensed resources so that the UE can transmit the data packet.

In some examples, logical channels can be configured to enable/disable the functionality disclosed in for example the method 100 of FIG. 1

A special resource, e.g. a PUCCH resource, may be used for SR transmission relating to data that will also be attempted for transmission on unlicensed spectrum. This way, the base station may be able to distinguish such SR transmissions from other SR transmissions of this UE relating for example to data that will not be transmitted on the unlicensed spectrum (and no attempts to do so will be made).

In some examples, it is indicated in the transmission on unlicensed spectrum, e.g. in MAC CE or in a physical channel information element, that an SR was triggered for the same data on unlicensed spectrum—that is, an attempt was or will be made to transmit the same data on unlicensed spectrum. Furthermore, in some examples, Buffer Status Report (BSR)-like information can be included in this MAC CE. The base station may be able to use this information to know if the configured grant (CG) resources are enough for the transmission, or if not the base station may schedule further dedicated resources on licensed spectrum (i.e. avoid cancelling scheduling based on this SR request). Alternatively, for example, the special UE resource usage (predetermined resources) for transmission of such SRs may be a particular logical channel or logical channel group (LCG) SR configuration for which PUCCH resources for SR on a BWP is available and used in cases for when transmission resources may only be available and used on an unlicensed carrier. In some examples, a MAC PDU may be transmitted on an unlicensed carrier and this MAC PDU may contain data for a logical channel (LCH) triggering the special SR (i.e. the data for the LCH is also the data that would be transmitted if a scheduling grant is given in response to the SR), a BSR MAC CE which contains buffer status of the LCH, or a combination of the two. In some examples, the particular SR (i.e. receiving a SR including a particular indication or on a particular resource) can be regarded as an indication that transmission on unlicensed spectrum was or will be attempted, e.g. CCA or LBT was or will be started.

In another example, the base station may only ignore the SR after a certain timer (“pending SR timer”) following the SR reception has expired and still no successful reception on unlicensed has been determined. The value of the timer may be configured in some examples in a way so that the latency requirement of the traffic can still be fulfilled. For example, the total of the timer value, scheduling time (grant processing and transmission) and PUSCH processing and transmission may be less than or equal to the delay budget. The timer value may in some examples depend on the type of the traffic or a delay budget corresponding to a traffic type. As a non limiting example, a separate timer value may be configured for each traffic type, e.g. per logical channel.

In some examples, the base station may only ignore the SR and does not schedule the UE on licensed spectrum if the base station manages to correctly decode the transmission on the unlicensed spectrum. Additionally or alternatively, for example, the base station only ignores the SR and does not schedule the UE on licensed spectrum if the UE has enough resources on the unlicensed spectrum to send the available data.

The UE may in some examples not send an SR every time data becomes available. An SR prohibit timer for example limits how frequently the UE is allowed to send this special SR (that is, a SR for data for which an attempt to transmit on the unlicensed spectrum will also be made). The UE may in some examples trigger another SR request if the pending SR timer expired and the UE failed to successfully transmit on the unlicensed carrier, and no resources were (yet) scheduled on the licensed carrier.

When new data arrives for transmission, in some examples, the UE is allowed to trigger an SR under one or more of the following conditions:
The UE does not have any scheduled resources on the licensed carrier
The UE is not occupying any unlicensed spectrum.
   And/or resources available for transmission on unlicensed spectrum are not enough to transmit all the available data.
The UE is at risk of exceeding the delay budget for the data, e.g. if the UE is not allocated dedicated resources on licensed carrier for transmission, the reliability targets will not be fulfilled.

In some examples, the base station may not cancel the scheduling in licensed spectrum. The UE may, to assist in enhancing the performance, trigger the SR with more than one configuration (e.g. primary and secondary configurations), such that the base station can allocate resources depending on triggered SR configuration, and/or a LCH in a successfully received, unlicensed transmission, if any. Additionally or alternatively, in some examples, the base station may allocate licensed resources based on secondary SR configuration of option if data of LCHs on were successfully received on unlicensed spectrum. Otherwise, the base station may should allocate licensed resources based on the primary SR configuration. Thus, for example, the scheduling request may in some examples comprise a first configuration for requesting resources for transmission of the data from the wireless device to the base station using licensed spectrum, and the scheduling request further comprises a second configuration for requesting resources for transmission of other data from the wireless device to the base station using licensed spectrum. Methods in some examples (e.g. the method 200 described above) may in some examples comprise scheduling resources based on the second configuration if the data is received using unlicensed spectrum. That is, for example, resources may be scheduled for the other data (and a corresponding scheduling grant transmitted to the wireless device) if the scheduling grant is no longer needed for the original data, which has been received on unlicensed spectrum. In the alternative scenario, methods in some examples may comprise scheduling resources based on the first configuration if the data is not received using unlicensed spectrum (e.g. within a certain period of time following receipt of the scheduling request). In some examples, the original data may be associated with a first logical channel to which the first configuration relates, and the other data may be associated with a second logical channel to which the second configuration relates. The other data may be for example data with a less stringent reliability and/or latency requirement than the original data (which may be e.g. URLLC data).

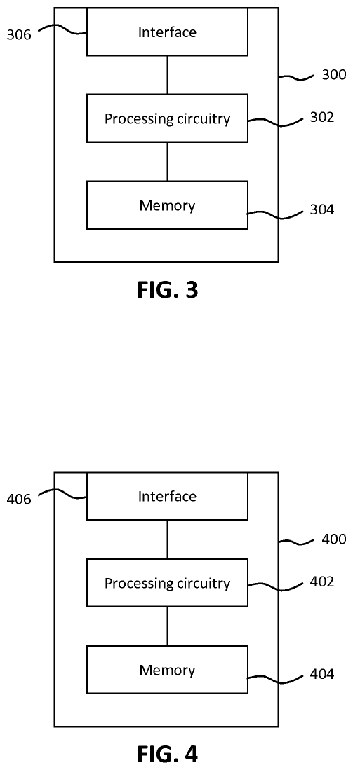

FIG. 3 is a schematic of an example of apparatus 300, such as for example a wireless device or UE. The apparatus 300 comprises processing circuitry 302 (e.g. one or more processors) and a memory 304 in communication with the processing circuitry 302. The memory 304 contains instructions executable by the processing circuitry 302. The apparatus 300 also comprises an interface 306 in communication with the processing circuitry 302. Although the interface 306, processing circuitry 302 and memory 304 are shown connected in series, these may alternatively be interconnected in any other way, for example via a bus.

In one embodiment, the memory 304 contains instructions executable by the processing circuitry 302 such that the apparatus 300 is operable to initiate a procedure to determine whether a channel in unlicensed spectrum for transmission of data to a base station using unlicensed spectrum is occupied, and before completion of the procedure, transmit a scheduling request to the base station, the scheduling request for transmission of the data to the base station using licensed spectrum. In some examples, the apparatus 300 is operable to carry out the method 100 described above with reference to FIG. 1.

FIG. 4 is a schematic of an example of apparatus 400, such as for example a base station or gNB. The apparatus 400 comprises processing circuitry 402 (e.g. one or more processors) and a memory 404 in communication with the processing circuitry 402. The memory 404 contains instructions executable by the processing circuitry 402. The apparatus 400 also comprises an interface 406 in communication with the processing circuitry 402. Although the interface 406, processing circuitry 402 and memory 404 are shown connected in series, these may alternatively be interconnected in any other way, for example via a bus.

In one embodiment, the memory 404 contains instructions executable by the processing circuitry 402 such that the apparatus 400 is operable to receive a scheduling request for transmission of data from a wireless device, the scheduling request for transmission of the data from the wireless device to the base station using licensed spectrum, and determine that the wireless device will attempt to transmit the data to the base station using unlicensed spectrum. In some examples, the apparatus 400 is operable to carry out the method 200 described above with reference to FIG. 2.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method performed by a wireless device, the method comprising:
initiating a procedure to determine whether a channel in unlicensed spectrum for transmission of data to a base station using unlicensed spectrum is occupied; and
before completion of the procedure, transmitting a scheduling request to the base station, the scheduling request for transmission, using unlicensed spectrum, of the data to the base station.

2. The method of claim 1, further comprising initiating transmission of the scheduling request one of simultaneously with initiating the procedure and before initiating the procedure.

3. The method of claim 1, further comprising, after completion of the procedure, transmitting the data to the base station using the unlicensed spectrum.

4. The method of claim 3, wherein the procedure indicates that the channel is not occupied.

5. The method of claim 3, further comprising receiving a scheduling grant for transmitting the data on licensed spectrum after transmitting the data to the base station using the unlicensed spectrum.

6. The method of claim 5, further comprising ignoring the scheduling grant.

7. The method of claim 3, further comprising cancelling preparations for transmission of the data on licensed spectrum at least one of after transmitting the data to the base station using the unlicensed spectrum and if transmitting the data to the base station using the unlicensed spectrum is successful.

8.-10. (canceled)

11. The method of claim 3, further comprising including an indication with the data that the scheduling request for transmission of the data was transmitted to the base station.

12. The method of claim 1, wherein the procedure indicates that the channel for transmission of the data to the base station using unlicensed spectrum is occupied.

13. The method of claim 12, further comprising receiving a scheduling grant for transmission of the data to the base station using licensed spectrum, and transmitting the data to the base station using licensed spectrum.

14. The method of claim 1, further comprising transmitting the scheduling request using at least one of a predetermined resource and a logical channel, wherein transmitting the scheduling request using the at least one of the predetermined resource and the logical channel indicates that the wireless device has initiated a LBT procedure for transmission of the data to the base station using unlicensed spectrum.

15.-21. (canceled)

22. A method performed by a base station, the method comprising:
receiving a scheduling request for transmission of data from a wireless device, the scheduling request for transmission, using licensed spectrum, of the data from the wireless device to the base station; and
determining that the wireless device will attempt to transmit the data to the base station using unlicensed spectrum.

23. The method of claim 22, further comprising ignoring the scheduling request on receiving the data using unlicensed spectrum.

24. The method of claim 22, wherein determining that the wireless device will attempt to transmit the data to the base station using unlicensed spectrum comprises receiving the data on unlicensed spectrum.

25. The method of claim 24, wherein determining that the wireless device will attempt to transmit the data to the base station using unlicensed spectrum comprises determining an indication received with the data received on unlicensed spectrum indicates that the scheduling request corresponds to the data.

26.-37. (canceled)

38. A wireless device comprising a processor and a memory, the memory containing instructions executable by the processor such that the apparatus is configured to:
initiate a procedure to determine whether a channel in unlicensed spectrum for transmission of data to a base station using unlicensed spectrum is occupied; and
before completion of the procedure, transmit a scheduling request to the base station, the scheduling request for transmission, using licensed spectrum, of the data to the base station.

39. The wireless device of claim 38, wherein the memory contains instructions executable by the processor such that the apparatus is further configured to initiate transmission of the scheduling request one of simultaneously with initiating the procedure and before initiating the procedure.

40. A base station comprising a processor and a memory, the memory containing instructions executable by the processor such that the apparatus is configured to:
receive a scheduling request for transmission of data from a wireless device, the scheduling request for transmission, using licensed spectrum, of the data from the wireless device to the base station; and
determine that the wireless device will attempt to transmit the data to the base station using unlicensed spectrum.

41. The base station of claim 40, wherein the memory contains instructions executable by the processor such that the apparatus is further configured to ignore the scheduling request on receiving the data using unlicensed spectrum.

42. (canceled)

43. (canceled)
